(19) United States
(12) Patent Application Publication
(10) Pub. No.: US 2026/0097690 A1
(43) Pub. Date: Apr. 9, 2026

(54) VEHICLE SEAT

(71) Applicant: TS TECH CO., LTD., Asaka-shi, Saitama (JP)

(72) Inventors: Takashi HIROKI, Tochigi (JP); Haruhiko KAWADA, Tochigi (JP)

(21) Appl. No.: 19/112,755

(22) PCT Filed: Dec. 19, 2023
(86) PCT No.: PCT/JP2023/045522

§ 371 Date: Mar. 18, 2025

Related U.S. Application Data
(60) Provisional application No. 63/476,515, filed on Dec. 21, 2022.

(51) Int. Cl. B60N 2/00

(52) U.S. Cl. CPC B60N 2/0033; B60N 2210/40

(57) ABSTRACT

There is provided a conveyance seat in which a detection sensor can be easily attached to a pad material. A conveyance seat includes a detection sensor that detects a biometric signal of a seated occupant; and an attachment member for attaching the detection sensor to a second pad material. An accommodation portion that is provided to be recessed in a thickness direction of a pad material and that accommodates the detection sensor via the attachment member is formed on a front surface of the second pad material. The attachment member includes a recess that accommodates the detection sensor, an outer peripheral portion extending outward from the recess and disposed on the front surface of the second pad material, and a locking portion that is provided on the outer peripheral portion, and that locks to a locked portion formed in the accommodation portion.

### TECHNICAL FIELD

The present invention relates to a conveyance seat, particularly to a conveyance seat including a pad material.

### BACKGROUND ART

Conventionally, a conveyance seat including a pad material and a detection sensor disposed below the pad material has been known. For example, PATENT LITERATURE 1 describes that a detection sensor is attached to a conveyance seat by being placed on a base (attachment member) attached to a pair of adjacent S-springs among a plurality of the S-springs stretched across a frame of the conveyance seat. The base is attached to the S-springs by hook portions extending outward from a placement portion on which the detection sensor is placed.

### CITATION LIST

### Patent Literature

PATENT LITERATURE 1: JP 2018-058586 A

### SUMMARY OF INVENTION

### Technical Problem

Generally, in a conveyance seat, in addition to a structure in which a pad material is supported by S-springs, a structure in which a pad material on a front surface of the conveyance seat is supported by a pad material having different hardness is used. Therefore, a structure in which a detection sensor can be easily attached to a member other than the S-springs has been required.

The present invention has been made in view of the above-described problem, and an object of the present invention is to provide a conveyance seat in which detection sensor can be easily attached to a pad material.

### Solution to Problem

The above-described problem is solved by a conveyance seat including a pad material; a detection sensor that detects a biometric signal of a seated occupant; and an attachment member for attaching the detection sensor to the pad material. An accommodation portion that is provided to be recessed in a thickness direction of the pad material and that accommodates the detection sensor via the attachment member is formed on a front surface of the pad material. The attachment member includes a recess that accommodates the detection sensor, an outer peripheral portion extending outward from the recess and disposed on the front surface of the pad material, and a locking portion that is provided on the outer peripheral portion, and that locks to a locked portion formed in the accommodation portion.

With the above-described configuration, by disposing the outer peripheral portion of the attachment member on the front surface of the pad material, the detection sensor can be easily attached to the pad material. In addition, by attaching the attachment member with reference to the front surface of the pad material, the influence of tolerances of the pad material can be reduced. Further, since the locking portion is hooked and attached to the locked portion of the pad material, the falling off of the attachment member from the pad material can be suppressed.

Therefore, the detection sensor can be easily attached to the pad material by the attachment member.

In this case, it is preferable that the locked portion is a through-hole formed in an inner wall of the accommodation portion and penetrating through the inner wall in a direction intersecting the thickness direction of the pad material. It is preferable that the locking portion extends from the outer peripheral portion in the thickness direction of the pad material, bends outward, and locks to the through-hole.

With the above-described configuration, since the locking portion is locked to the through-hole, the detection sensor can be more easily attached to the pad material.

In this case, it is preferable that the attachment member includes a positioning rib that extends from a back surface of the outer peripheral portion and comes into contact with the front surface of the pad material to determine an attachment position of the detection sensor in the thickness direction of the pad material.

With the above-described configuration, the detection sensor can be easily attached to the pad material with high accuracy simply by attaching the attachment member in the thickness direction of the pad material.

In this case, it is preferable that the detection sensor is a seating sensor that detects a seating state of the seated occupant, and turns on or off depending on a seating pressure of the seated occupant.

With the above-described configuration, since the detection sensor can be stably attached to the pad material by the attachment member, even with a push type seating sensor in which a circuit is conducted depending on the load of the seated occupant, the seating state of the seated occupant can be detected with high accuracy.

In this case, it is preferable that a plurality of the accommodation portions are formed spaced apart from each other in a seat width direction.

With the above-described configuration, by providing the plurality of accommodation portions, seating feeling at a position where the detection sensor is not attached can be improved.

In this case, it is preferable that the pad material includes a first pad material and a second pad material formed to be harder than the first pad material and disposed to overlap a back surface of the first pad material. It is preferable that the accommodation portion is provided on the back surface of the first pad material or a facing surface of the second pad material facing the first pad material.

With the above-described configuration, the detection sensor can be suitably held while improving seating feeling.

In this case, it is preferable that the second pad material is made of expanded polypropylene.

With the above-described configuration, the rigidity of the second pad material can be increased, and the detection sensor can be suitably held.

In this case, it is preferable that the attachment member includes a pawl portion provided on a bottom portion of the recess and extending from the bottom portion in a direction in which the recess is recessed.

With the above-described configuration, the attachment member can be attached to the pad material at a position other than the locked portion by the pawl portion formed at a position different from that of the locking portion extending from the outer peripheral portion. In addition, the attachment member can be attached to a member other than the pad material (for example, a plate-shaped member such as a pan frame) by the pawl portion. Therefore, the versatility of the attachment member can be enhanced.

### Advantageous Effects of Invention

According to the present invention, the detection sensor can be easily attached to the pad material.

In addition, according to the present invention, the detection sensor can be more easily attached to the pad material.

In addition, according to the present invention, the attachment member can be easily locked to the pad material.

In addition, according to the present invention, the seating state of the seated occupant can be detected with high accuracy.

In addition, according to the present invention, seating feeling can be improved.

In addition, according to the present invention, the detection sensor can be suitably held while improving seating feeling.

In addition, according to the present invention, the rigidity of the second pad material can be increased, and the detection sensor can be suitably held.

In addition, according to the present invention, the versatility of the attachment member can be enhanced.

### BRIEF DESCRIPTION OF DRAWINGS

FIG. 1 is an external perspective view of a conveyance seat of the present embodiment.

FIG. 2 is a cross-sectional view of a seat cushion.

FIG. 3 is an exploded perspective view of a pad material (a first pad material and a second pad material) of the seat cushion.

FIG. 4 is an enlarged view of a main portion of the second pad material.

FIG. 5 is a cross-sectional view taken along line V-V of FIG. 4, and is a view showing a state where an attachment member is locked to the pad material.

FIG. 6 FIG. is a perspective view of the attachment member and a detection sensor.

FIG. 7 is a perspective view of the attachment member.

### DESCRIPTION OF EMBODIMENTS

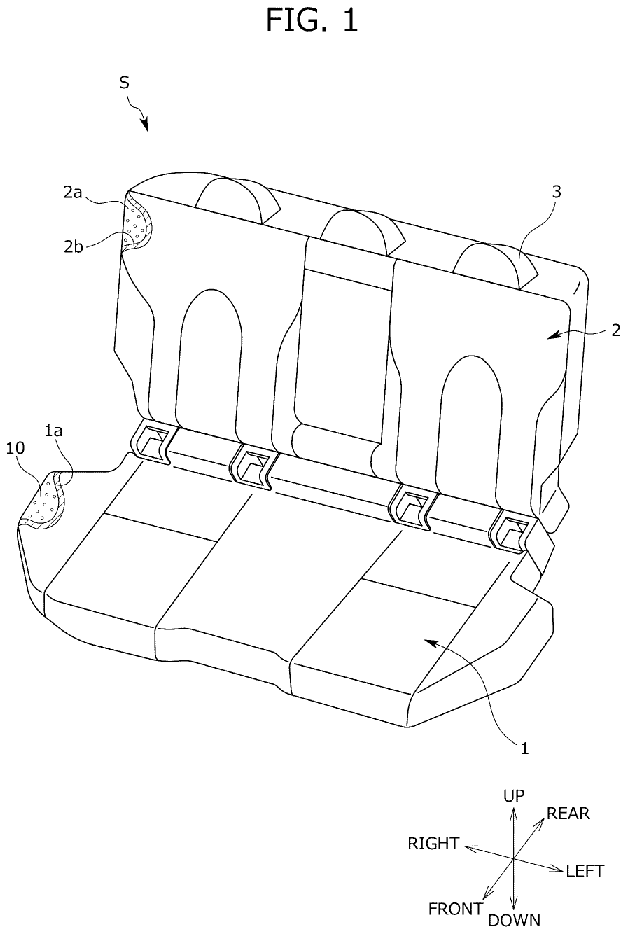

Hereinafter, an embodiment according to the present invention will be described with reference to FIGS. 1 to 7. Incidentally, in the following description, the “front to rear direction” is a front to rear direction of a conveyance seat, and is a direction coinciding with a traveling direction when a vehicle travels. In addition, the “seat width direction” is a lateral width direction of the conveyance seat (in other words, a width direction of a seat body), and is a direction coinciding with a right to left direction when viewed from an occupant seated in the conveyance seat. In addition, the “up to down direction” is an up to down direction of the conveyance seat, and is a direction coinciding with a vertical direction when the vehicle travels on a horizontal surface.

As shown in FIG. 1, a conveyance seat S of the present embodiment is a vehicle seat, for example, a rear seat of an automobile which is placed on a vehicle body floor and in which three occupants can be seated. However, the conveyance seat S is not limited thereto, and the conveyance seat S may be a front seat disposed on the front side of the vehicle, and can also be used as a middle seat in a second row or a rear seat in a third row in a vehicle including three rows of seats in the front to rear direction.

As shown in FIGS. 1 to 3, the conveyance seat S is mainly composed of a seat body including a seat cushion 1, a seat back 2, and a headrest 3; a detection sensor 4 that is attached to the inside of the seat body, and that detects a biometric signal of the seated occupant; and an attachment member 5 for attaching the detection sensor 4 to the seat cushion 1.

As shown in FIG. 1, the seat cushion 1 is a seating portion that supports the seated occupant from below, and is configured by covering a pad material 10 serving as the body portion of the seat cushion 1 with a skin material 1a.

As shown in FIG. 1, the seat back 2 is a backrest portion that supports the back of the seated occupant from behind, and is configured by covering a pad material 2a with a skin material 2b.

As shown in FIG. 1, the headrest 3 is a head support portion that supports the head of the seated occupant from the direction, and is configured by covering a pad material (not shown) with a skin material.

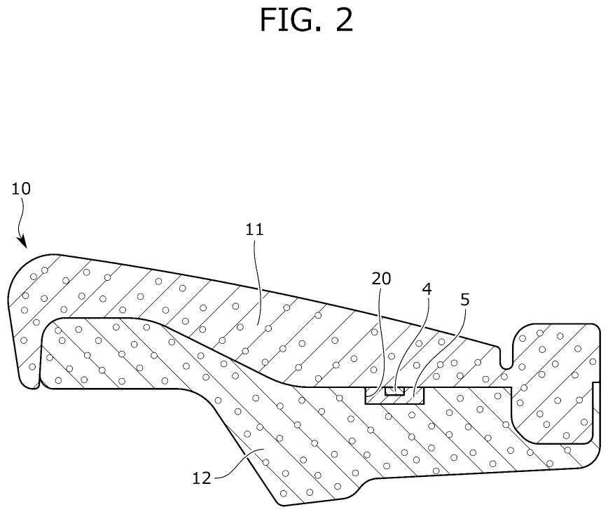

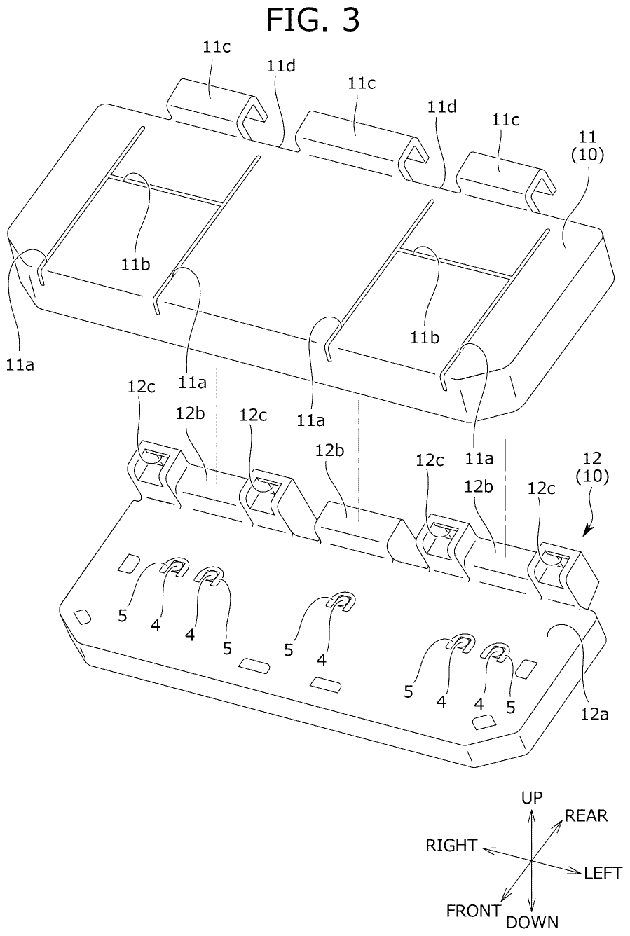

As shown in FIG. 2, the detection sensor 4 is attached to the inside of the pad material 10 (specifically, an accommodation portion 20 of a second pad material 12) via the attachment member 5. As shown in FIG. 3, a plurality of the detection sensors 4 are provided spaced apart from each other in the seat width direction, and are each disposed at the positions of hip points of the seated occupant or the positions corresponding to the vicinities of the hip points. In addition, each of the detection sensors 4 detects a seating pressure independently, and outputs a detection signal based on the detection result of the seating pressure.

### Pad Material

As shown in FIGS. 2 and 3, the pad material 10 is a pad stack formed by stacking a plurality of pad materials one on top of the other, and includes a first pad material 11 disposed on an upper side (seated occupant side), and the second pad material 12 formed to be harder than the first pad material 11 and disposed on a lower side (vehicle body side).

The first pad material 11 is disposed on an upper surface of the second pad material 12, and is attached to cover the second pad material 12 from above.

In detail, when the first pad material 11 and the second pad material 12 are assembled together, the first pad material 11 is in contact with substantially the entire upper surface, front surface, and both side surfaces of the second pad material 12, and is in contact with a part of a rear surface of the second pad material 12.

In addition, when the first pad material 11 and the second pad material 12 are assembled together, a part of a rear portion of the second pad material 12 (anchor passage portion 12c) is exposed upward.

### First Pad Material

The first pad material 11 is formed from, for example, a resin material such as urethane foam. As shown in FIG. 3, a first skin pull-in groove 11a and a second skin pull-in groove 11b for pulling in the skin material 1a are formed on a front surface of the first pad material 11.

A plurality of the first skin pull-in grooves 11a are longitudinal pull-in grooves formed spaced apart from each other in the seat width direction and extending the seat front to rear direction.

The second skin pull-in groove 11b is a lateral pull-in groove formed substantially in a central portion of the front surface of the first pad material 11 in the seat front to rear direction and extending in the seat width direction. The second skin pull-in groove 11b connects the adjacent first skin pull-in grooves 11a.

A plurality of attachment portions 11c having a hook shape that are provided spaced apart from each other in the seat width direction and that are attached t to attached portions 12b provided in the second pad material 12, and opening portions 11d disposed between the adjacent attachment portions 11c are formed at a rear end portion of the first pad material 11. The anchor passage portion 12c of the second pad material 12 is exposed upward through the opening portion 11d.

In the above-described configuration, the detection sensor 4 and both the first skin pull-in groove 11a and the second skin pull-in groove 11b are disposed at different positions (positions that do not overlap each other in the up to down direction) when viewed from above. Specifically, in FIG. 3, the detection sensors 4 are disposed at positions overlapping a region between the adjacent first skin pull-in grooves 11a and in front of the second skin pull-in groove 11b in the up to down direction.

By disposing the detection sensors 4 so as to avoid positions directly below the first skin pull-in grooves 11a and the second skin pull-in groove 11b in such a manner, the detection performance of the detection sensors 4 with respect to seating pressure can be enhanced.

### Second Pad Material

The second pad material 12 is formed from, for example, a resin material such as expanded polypropylene. As shown in FIGS. 2 and 3, the second pad material 12 is formed to be harder than the first pad material 11, and the second pad material 12 is disposed to overlap a back surface of the first pad material 11. In other words, the second pad material 12 is provided on a back surface side of the first pad material 11, and is disposed to overlap the first pad material 11 in the up to down direction.

As shown in FIG. 3, a plurality of the attached portions 12b having a protruding shape that are provided spaced apart from each other in the seat width direction and that are attached to the attachment portions 11c of the first pad material 11, and the anchor passage portions 12c disposed between the adjacent attachment portions 11c are formed at a rear end portion of the second pad material 12.

The anchor passage portions 12c are passage holes for passing anchor members (extension members) (not shown), specifically, passage holes for passing the anchor members for connecting a child safety seat.

Incidentally, the anchor members are attached to a vehicle body, and are assembled in a state where the anchor members pass through the anchor passage portions 12c from the vehicle body and protrude forward from the seat body.

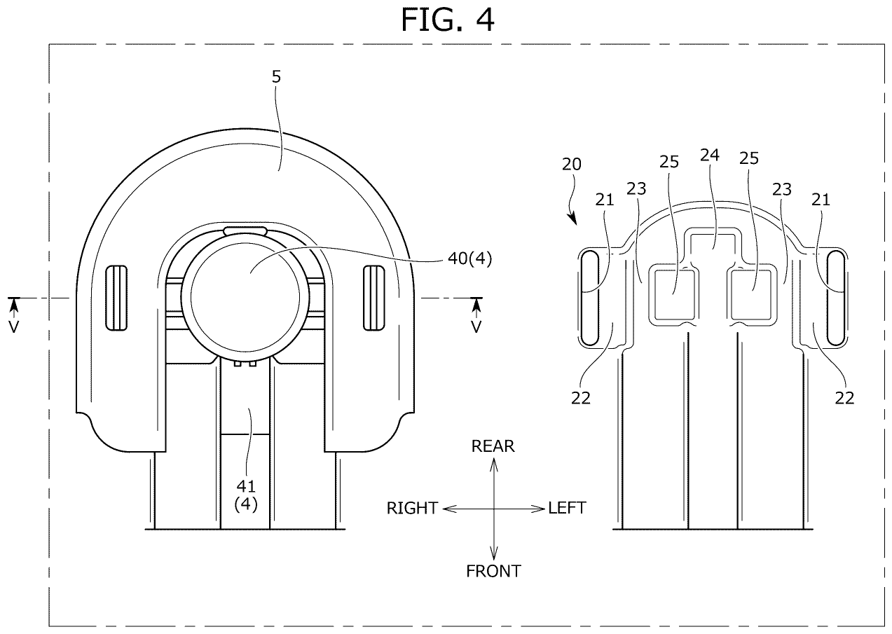

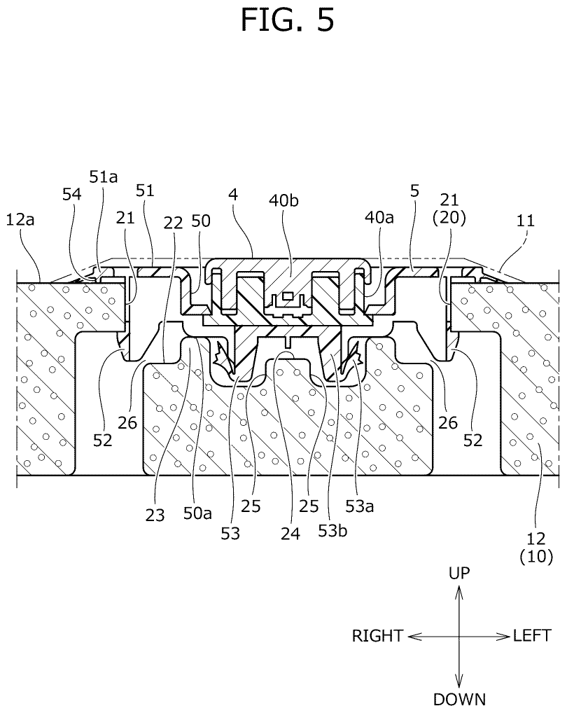

As shown in FIGS. 4 and 5, the accommodation portions 20 that are provided to be recessed in a thickness direction of the pad material 10 and that accommodate the detection sensors 4 via the attachment members 5 are formed on a front surface 12a of the second pad material 12.

FIG. 4 shows two adjacent accommodation portions 20 in the second pad material 12. The right accommodation portion 20 in FIG. 4 is in a state where the detection sensor 4 and the attachment member 5 are disposed therein. In addition, the left accommodation portion 20 in FIG. 4 is in a state where the detection sensor 4 and the attachment member 5 are removed therefrom.

Incidentally, an accommodation groove (not shown) that is provided continuously with the accommodation portion 20 and that accommodates a wire harness formed by bundling conductive wires may be formed on the front surface 12a of the second pad material 12.

### Accommodation Portion

As shown in FIG. 2, the accommodation portions 20 are storage recesses for accommodating the detection sensors 4, are formed on the front surface 12a of the second pad material 12, and are provided to face the back surface of the first pad material 11. As shown in FIG. 3, a plurality of the accommodation portions 20 are formed spaced apart from each other in the seat width direction. Specifically, one accommodation portion 20 is provided in a central portion of the second pad material 12 in the seat width direction, and two accommodation portions 20 are provided in each of both side portions of the second pad material 12.

Incidentally, the accommodation portions 20 are formed on the front surface 12a (a facing surface facing the first pad material 11) of the second pad material 12, but are not particularly limited, and may be formed on a back surface of the second pad material 12. Alternatively, the accommodation portions 20 may be formed on the back surface of the first pad material 11, or may be formed on the front surface of the first pad material 11.

As shown in FIGS. 4 and 5, the accommodation portion 20 includes inner walls 21; first bottom walls 22 provided at both side portions of the accommodation portion 20 in the seat width direction; protruding portions 23 provided inside the first bottom walls 22 in the seat width direction, and protruding upward from the first bottom walls 22; a second bottom wall 24 provided at a central portion of the accommodation portion 20 in the seat width direction; and recessed portions 25 provided to be recessed further downward from the second bottom wall 24 in the thickness direction of the pad material 10. In addition, locked portions 26 for locking the attachment member 5 are formed in the inner walls 21 of the accommodation portion 20.

The first bottom walls 22 are flat portions provided at both side portions of the accommodation portion 20 in the seat width direction and formed at positions in close proximity to the inner walls 21. Locking portions 52 are disposed on the first bottom walls 22.

The protruding portions 23 are provided inside the inner walls 21 of the accommodation portion 20 in the seat width direction, and protrude upward from inner end portions of the first bottom walls 22. Upper surfaces of the protruding portions 23 are flat, are located above the first bottom walls 22 and the second bottom wall 24, and are located below the front surface 12a of the second pad material 12 in the thickness direction of the pad material 10. When the detection sensor 4 and the attachment member 5 are disposed in the accommodation portion 20, the protruding portions 23 support a bottom portion 50a of a recess 50 of the attachment member 5.

The second bottom wall 24 is a flat portion formed at a center position of the accommodation portion 20 in the seat width direction. The second bottom wall 24 is located above the first bottom walls 22 in the thickness direction of the pad material 10. When the detection sensor 4 and the attachment member 5 are disposed in the accommodation portion 20, the second bottom wall 24 supports a connector portion 41 of the detection sensor 4.

The recessed portions 25 are provided between the protruding portions 23 and the second bottom wall 24 of the accommodation portion 20 in the seat width direction, and are provided to be further recessed from outer end portions of the second bottom wall 24 in the thickness direction of the pad material 10. In other words, the recessed portions 25 are provided in the accommodation portion 20 at positions corresponding to pawl portions 53 of the attachment member 5.

Bottom surfaces of the recessed portions 25 are flat and are located below the first bottom walls 22 and the second bottom wall 24 in the thickness direction of the pad material 10. When the detection sensor 4 and the attachment member 5 are disposed in the accommodation portion 20, the pawl portions 53 of the attachment member 5 are disposed in the recessed portions 25.

The locked portions 26 are through-holes formed in the inner walls 21 and penetrating therethrough in a direction intersecting the thickness direction of the pad material 10 (seat width direction). Specifically, the locked portions 26 are provided at both end portions of the accommodation portion 20 in the seat width direction, and are formed at lower end portions of the inner walls 21. The locked portions 26 are long holes extending in the seat front to rear direction, and have a shape that allows locking pawls 52b of the locking portions 52 to be hooked onto the locked portions 26.

Incidentally, the locked portions 26 extend outward in the seat width direction, and penetrate through the inner walls 21 so as to bend and extend downward. In other words, the second pad material 12 is penetrated continuously from the front surface 12a to the back surface via the locked portions 26.

### Detection Sensor

As shown in FIGS. 4 to 6, the detection sensor 4 is a pressure sensor having a sheet shape that detects a seating pressure applied to the seating surface of the seat cushion 1 when the seated occupant is seated in the seat, and is attached to a front surface of the pad material 10. Specifically, the detection sensor 4 is attached to the accommodation portion 20, which is formed on the front surface 12a of the second pad material 12, via the attachment member 5.

Here, the “seating pressure” is a value that changes periodically in response to the physiological activity of the seated occupant, specifically, breathing, in a state where the seated occupant is seated on the seat cushion 1, and is a target value that is detected by the pressure sensor. Incidentally, it is preferable that the detection sensor 4 is a seating sensor that detects the seating state of the seated occupant. More preferably, the detection sensor 4 is a push switch type seating sensor that turns on or off depending on the seating pressure of the seated occupant.

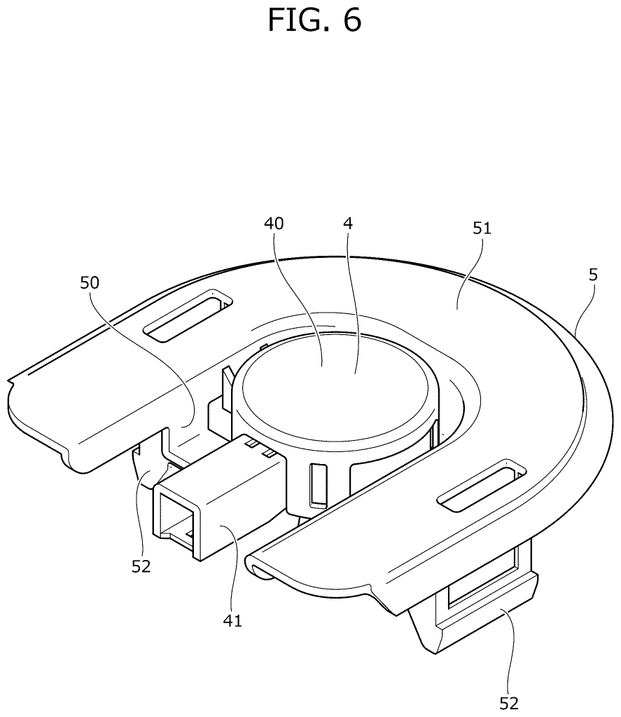

As shown in FIGS. 4 and 6, the detection sensor 4 includes a sensor body portion 40 that detects the seating pressure of the seated occupant, and the connector portion 41 for outputting a detection signal when the sensor body portion 40 detects the seating pressure.

The sensor body portion 40 includes a housing 40a that accommodates a sensor therein, and a pressing portion 40b that is pressed by the seated occupant. The housing 40a is attached to the attachment member 5 by being engaged with a first engagement portion 50c and second engagement portions 50d of the attachment member 5. When the pressing portion 40b is pressed by the seated occupant via the first pad material 11, the sensor body portion 40 outputs a detection signal.

The connector portion 41 electrically connects the sensor of the sensor body portion 40 to a control device (not shown) of the vehicle. The connector portion 41 extends from the sensor body portion 40 toward the front of the seat, and is electrically connected to a wire harness.

### Attachment Member

As shown in FIGS. 4 to 7, the attachment member 5 is an attachment for attaching the detection sensor 4 to the pad material 10. In detail, the attachment member 5 is disposed in the accommodation portion 20 of the second pad material 12 in a state where the detection sensor 4 is attached.

The attachment member 5 includes the recess 50 that accommodates the detection sensor 4; an outer peripheral portion 51 extending outward from the recess 50 and disposed on the front surface of the pad material 10; the locking portions 52 that are provided on the outer peripheral portion 51, and that lock to the locked portions 26 formed in the accommodation portion 20; the pawl portions 53 provided on the bottom portion 50a of the recess 50 and extending from the bottom portion 50a in a direction in which the recess 50 is recessed; and a positioning rib 54 that determines the attachment position of the detection sensor 4.

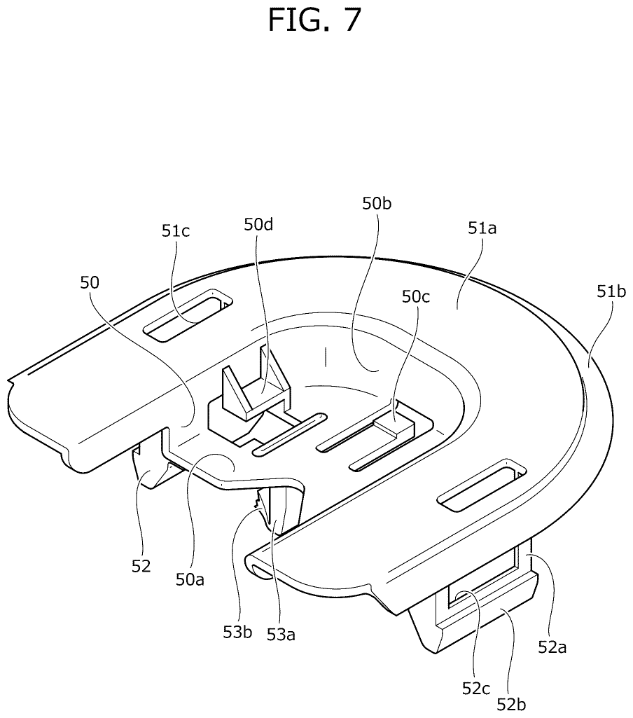

As shown in FIGS. 5 and 6, the recess 50 is provided in a center portion of the attachment member 5, and accommodates the detection sensor 4. As shown in FIG. 7, the recess 50 includes the bottom portion 50a that supports the sensor body portion 40 of the detection sensor 4 from below; a side wall portion 50b that supports the sensor body portion 40 from the side; the first engagement portion 50c provided on the bottom portion 50a; and the second engagement portions 50d provided on the side wall portion 50b.

The bottom portion 50a is a flat portion that supports the sensor body portion 40 from below. The first engagement portion 50c that engages with the housing 40a is formed at a rear end portion of the bottom portion 50a.

The side wall portion 50b is a wall portion p that supports the sensor body portion 40 from the side. The second engagement portions 50d that engage with the housing 40a are formed at both end portions of the side wall portion 50b in the seat width direction.

As shown in FIGS. 5 to 7, the outer peripheral portion 51 has an inverted U-shape when viewed from above, and is disposed to surround the detection sensor 4. The outer peripheral portion 51 is formed continuously with the side wall portion 50b of the recess 50, and includes a base portion 51a extending outward from an opening end portion of the recess 50; an inclined portion 51b extending outward from an outer edge portion of the base portion 51a; and hole portions 51c formed in the base portion 51a.

The base portion 51a is disposed above the accommodation portion 20 and the second pad material 12. The positioning rib 54 is formed on a back surface of the base portion 51a. In addition, the hole portions 51c are formed at both side portions of the base portion 51a in the seat width direction.

When the attachment member 5 is attached to the accommodation portion 20 by the locking portions 52, the base portion 51a is disposed to cover the front surface 12a of the second pad material 12.

The inclined portion 51b is formed continuously with the base portion 51a, and is provided to extend downward and outward from the outer edge portion of the base portion 51a. An outer end portion of the inclined portion 51b comes into contact with the front surface 12a of the second pad material 12.

The hole portions 51c are holes penetrating through the base portion 51a in the up to down direction, and are formed at both side portions of the base portion 51a in the seat width direction. For example, a harness for an electronic device or the like disposed above the second pad material 12 may be inserted through the hole portion 51c. Specifically, the harness inserted into the hole portion 51c from above extends downward, passes through the locked portion 26 (through-hole), and is disposed to extend to the back surface of the second pad material 12.

As shown in FIGS. 5 to 7, the locking portions 52 are long in the front to rear direction, extend from the outer peripheral portion 51 in the thickness direction of the pad material 10, bend outward, and lock to the locked portions 26.

Each of the locking portions 52 includes an extension portion 52a extending from the outer peripheral portion 51 in the thickness direction of the pad material 10, and the locking pawl 52b bent outward from the extension portion 52a.

The extension portion 52a extends downward from the base portion 51a in the vicinity of the hole portion 51c. An opening 52c penetrating through the extension portion 52a in the seat width direction is formed in the extension portion 52a.

The locking pawl 52b is a portion that locks to the locked portion 26, and protrudes outward in the seat width direction from a lower end portion of the extension portion 52a.

As shown in FIGS. 5 to 7, the pawl portions 53 are portions provided on the bottom portion 50a of the recess 50 and extending from the bottom portion 50a in the direction in which the recess 50 is recessed. Each of the pawl portions 53 includes an extension portion 53a extending downward from the bottom portion 50a, and an engaging pawl 53b protruding outward in the seat width direction from the extension portion 53a.

The extension portion 53a extends downward from the bottom portion 50a. A lower end portion of the extension portion 53a bends outward.

The engaging pawl 53b protrudes outward in the seat width direction from the lower end portion of the extension portion 53a. A plurality of projections protruding outward are formed at an outer end portion of the engaging pawl 53b.

The pawl portions 53 are stored in the recessed portions 25 of the accommodation portion 20. The engaging pawls 53b are configured not to engage with the second pad material 12 when the engaging pawls 53b are disposed in the accommodation portion 20 of the second pad material 12. Namely, the engaging pawls 53b are used to attach the attachment member 5 to an accommodation portion or a pad material other than that of the present embodiment, or a member other than the pad material.

For example, when the attachment member 5 is attached to a plate-shaped member such as a pan frame, the detection sensor 4 and the attachment member 5 can be attached to the conveyance seat S by engaging the engaging pawls 53b with engaged portions formed in the pan frame.

In such a manner, by providing the pawl portions 53 at positions different from those of the locking portions 52, the attachment member 5 can be attached to the pad material 10 at a position other than the locked portions 26 of the accommodation portion 20. In addition, the attachment member 5 can be attached to a member other than the pad material 10 or the like by the pawl portions 53. Therefore, the versatility of the attachment member 5 can be enhanced.

Incidentally, the engaging pawls 53b may be in contact with inner wall portions of the recessed portions 25. By engaging the engaging pawls 53b with the recessed portions 25, the engagement force of the attachment member 5 with respect to the second pad material 12 may be improved. In this case, the engaging pawls 53b may be engaged with the second pad material 12 by causing the plurality of projections, which are formed in the engaging pawls 53b, to bite into the second pad material 12.

As shown in FIGS. 5 to 7, the positioning rib 54 is provided on a back surface (lower surface) of the outer edge portion of the base portion 51a, and extends from a back surface of the outer peripheral portion 51 and comes into contact with the front surface 12a of the second pad material 12 to determine the attachment position of the detection sensor 4 in the thickness direction of the second pad material 12.

A lower end portion of the positioning rib 54 comes into contact with the front surface 12a of the second pad material 12. In such a manner, the position of the attachment member 5 with respect to the second pad material 12 can be determined simply by attaching the attachment member 5 to the front surface 12a of the second pad material 12 from above. Therefore, the detection sensor 4 can be easily attached to the pad material 10 with high accuracy.

With the above-described configuration, for example, even if an error occurs in the design value of the depth of the accommodation portion 20 when the second pad material 12 is formed by foaming, the up-and-down position of the detection sensor 4 with respect to the seating surface (the position of the pad material 10) can be easily aligned with high accuracy simply by placing the outer peripheral portion 51 on the front surface 12a of the second pad material 12.

In addition, the attachment member 5 can be stably attached to the second pad material 12 by the outer peripheral portion 51 formed to extend outward from the recess 50 that accommodates the detection sensor 4. Further, the locking force of the attachment member 5 with respect to the second pad material 12 can be increased by the locking portions 52 provided on the outer peripheral portion 51.

### Other Embodiments

In the above-described embodiment, as shown in FIG. 2, the pad material 10 is configured by stacking the first pad material 11 and the second pad material 12; however, the configuration is not particularly limited.

For example, the pad material 10 may be configured by stacking three or more pad materials. In this case, it is preferable that in the pad material 10, a first pad material located closest to the seated occupant side is relatively soft, and a second pad material and the subsequent pad materials are harder than the first pad material. In addition, in this case, it is preferable that the detection sensor 4 is attached to a front surface or a back surface of the second pad material or the third pad material that is relatively hard.

In the above-described embodiment, the conveyance seat used in automobiles has been described as a specific example; however, the present invention is not particularly limited, and can be used for various seats such as office chairs for work, wheelchairs, and child chairs for shopping carts, in addition to two-wheeled seats for two-wheeled vehicles, vehicle seats for trains, buses or the like, and conveyance seats for airplanes, ships, or the like.

In the present embodiment, the conveyance seat according to the present invention has been mainly described. However, the above-described embodiment is merely one example for easy understanding of the present invention, and does not limit the present invention. The present invention can be modified and improved without departing from the concept of the present invention, and it goes without saying that the present invention includes its equivalents.

### REFERENCE SIGNS LIST

S: conveyance seat
1: seat cushion
1a: skin material
2: seat back
2a: pad material
2b: skin material
3: headrest
4: detection sensor
5: attachment member
10: pad material
11: first pad material
11a: first skin pull-in groove
11b: second skin pull-in groove
11c: attachment portion
11d: opening portion
12: second pad material
12a: front surface
12b: attached portion
12c: anchor passage portion
20: accommodation portion
21: inner wall
22: first bottom wall
23: protruding portion
24: second bottom wall
25: recessed portion
26: locked portion
40: sensor body portion
40a: housing
40b: pressing portion
41: connector portion
50: recess
50a: bottom portion
50b: side wall portion
50c: first engagement portion
50d: second engagement portion
51: outer peripheral portion
51a: base portion
51b: inclined portion
51c: hole portion
52: locking portion
52a: extension portion
52b: locking pawl
52c: opening
53: pawl portion
53a: extension portion
53b: engaging pawl
54: positioning rib

1. A conveyance seat, comprising:
a pad material;
a detection sensor that detects a biometric signal of a seated occupant; and
an attachment member for attaching the detection sensor to the pad material,
wherein an accommodation portion that is provided to be recessed in a thickness direction of the pad material and that accommodates the detection sensor via the attachment member is formed on a front surface of the pad material, and
the attachment member includes a recess that accommodates the detection sensor, an outer peripheral portion extending outward from the recess and disposed on the front surface of the pad material, and a locking portion that is provided on the outer peripheral portion, and that locks to a locked portion formed in the accommodation portion.

2. The conveyance seat according to claim 1,
wherein the locked portion is a through-hole formed in an inner wall of the accommodation portion and penetrating through the inner wall in a direction intersecting the thickness direction of the pad material, and
the locking portion extends from the outer peripheral portion in the thickness direction of the pad material, bends outward, and locks to the through-hole.

3. The conveyance seat according to claim 1,
wherein the attachment member includes a positioning rib that extends from a back surface of the outer peripheral portion and comes into contact with the front surface of the pad material to determine an attachment position of the detection sensor in the thickness direction of the pad material.

4. The conveyance seat according to claim 1,
wherein the detection sensor is a seating sensor that detects a seating state of the seated occupant, and turns on or off depending on a seating pressure of the seated occupant.

5. The conveyance seat according to claim 1,
wherein a plurality of the accommodation portions are formed spaced apart from each other in a seat width direction.

6. The conveyance seat according to claim 1,
wherein the pad material includes a first pad material and a second pad material formed to be harder than the first pad material and disposed to overlap a back surface of the first pad material, and
the accommodation portion is provided on the back surface of the first pad material or a facing surface of the second pad material facing the first pad material.

7. The conveyance seat according to claim 6,
wherein the second pad material is made of expanded polypropylene.

8. The conveyance seat according to claim 1,
wherein the attachment member includes a pawl portion provided on a bottom portion of the recess and extending from the bottom portion in a direction in which the recess is recessed.
